(19) United States
(12) Patent Application Publication
(10) Pub. No.: US 2024/0171688 A1
(43) Pub. Date: May 23, 2024

(54) IMAGE FORMING DEVICE

(71) Applicant: SHARP KABUSHIKI KAISHA, Sakai City (JP)

(72) Inventor: Toshiyuki TABATA, Sakai City (JP)

(21) Appl. No.: 18/382,931

(22) Filed: Oct. 23, 2023

(30) Foreign Application Priority Data
Nov. 17, 2022 (JP) 2022-184411

(51) Int. Cl. H04N 1/00

(52) U.S. Cl. CPC H04N 1/00307; H04N 1/00076; H04N 1/00411; H04N 1/00559; H04N 2201/0094

(57) ABSTRACT

An image forming device includes: a housing; a near field communicator that performs near field communication with a mobile terminal; and a storage medium connector to which a storage medium is electrically connected, wherein the near field communicator and the storage medium connector are provided on a front surface of the housing, and a position of the near field communicator overlaps with a position of the storage medium connector in a vertical direction in a state where the near field communicator and the storage medium connector face the front surface of the housing.

### CROSS-REFERENCE TO RELATED APPLICATION

The present application claims priority from Japanese Application JP2022-184411, the content to which is hereby incorporated by reference into this application.

### BACKGROUND OF THE INVENTION

### 1. Field of the Invention

The present disclosure relates to an image forming device that performs near field communication with a mobile terminal.

### 2. Description of the Background Art

In recent years, an image forming device is equipped with an operation panel so as to receive an operation from a user. Moreover, the image forming device is connected to an external storage terminal or the like to employ a function of reading image data.

Incidentally, when both an operation panel and a terminal connection port are provided, the accessibility and visibility to the operation panel and the terminal connection port may be deteriorated depending on the arrangement of the respective components in a housing, and therefore, a method of improving the deterioration has been proposed.

### SUMMARY OF THE INVENTION

A conventional image forming device has a display that displays information and an operation acceptor that performs setting related to image formation. The image forming device includes a rotatable operation display provided on a front surface of a device main body and a USB port provided on a lateral surface of the device main body on a side close to the operation display.

In the above-described image forming device, in order to prevent a storage medium connected to the USB port from becoming an obstacle when the operation display is rotated, the USB port is provided on not the front surface that a user faces but the lateral surface of the device main body. Thus, it may take the user a long time to confirm an arrangement place or the user may forget to remove the connected storage medium.

The present disclosure has been made to solve the above problem, and an object of the present disclosure is to provide an image forming device capable of guiding a user to smoothly move his/her hand and eye gaze for respective components provided in a housing.

An image forming device according to the present disclosure is an image forming device including: a housing; a near field communicator that performs near field communication with a mobile terminal; and a storage medium connector to which a storage medium is electrically connected, in which the near field communicator and the storage medium connector are provided on a front surface of the housing, and a position of the near field communicator overlaps with a position of the storage medium connector in a vertical direction in a state where the near field communicator and the storage medium connector face the front surface of the housing.

The image forming device according to the present disclosure may be configured such that the near field communicator is located above the storage medium connector.

The image forming device according to the present disclosure may be configured to further include: an operation panel attached to the front surface of the housing and may be configured such that the near field communicator is provided on the operation panel.

The image forming device according to the present disclosure may be configured such that a display is provided on the operation panel, and the near field communicator is arranged adjacent to the display.

The image forming device according to the present disclosure may be configured such that the near field communicator is arranged on the right of the display.

The image forming device according to the present disclosure may be configured such that an inputter that receives input from a user is provided on the operation panel.

The image forming device according to the present disclosure may be configured such that the near field communicator is provided on an installation surface of the operation panel, and the inputter is provided on a lateral surface of the operation panel, which is adjacent to the installation surface.

The image forming device according to the present disclosure may be configured such that the near field communicator has a placement acceptor on which the mobile terminal is placed, and a supporter that supports the mobile terminal is provided at a lower end of the placement acceptor.

The image forming device according to the present disclosure may be configured to further include: a notifier that provides notification to a user by visual recognition and may be configured such that the notifier is provided on the front surface of the housing, and a position of the notifier overlaps with the position of the near field communicator in the vertical direction.

The image forming device according to the present disclosure may be configured such that the near field communicator and the storage medium connector are provided at an end portion on the same side in a lateral direction along the front surface of the housing.

According to the present disclosure, since the near field communicator and the storage medium connector are provided on the same surface of the housing, a user can install a mobile terminal and connect a storage medium in a state of standing and facing the front surface of the housing. Moreover, since the near field communicator and the storage medium connector are arranged in a straight line, the user can be guided to smoothly move his/her hand and eye gaze when performing an operation for both components.

### BRIEF DESCRIPTION OF THE DRAWINGS

FIG. 1 is an external perspective view illustrating an image forming device according to an embodiment of the present disclosure.

FIG. 2 is a schematic configuration diagram of the image forming device illustrated in FIG. 1.

FIG. 3 is a front view illustrating the image forming device as viewed from a front surface side of a housing.

FIG. 4 is a lateral view illustrating the image forming device as viewed from a lateral surface side of the housing.

FIG. 5 is an enlarged front view illustrating an enlarged vicinity of an operation panel as viewed from the front surface side of the housing.

FIG. 6 is an enlarged lateral view illustrating the enlarged vicinity of the operation panel as viewed from the lateral surface side of the housing.

### DETAILED DESCRIPTION OF THE INVENTION

Hereinafter, an image forming device according to an embodiment of the present disclosure will be described with reference to the drawings.

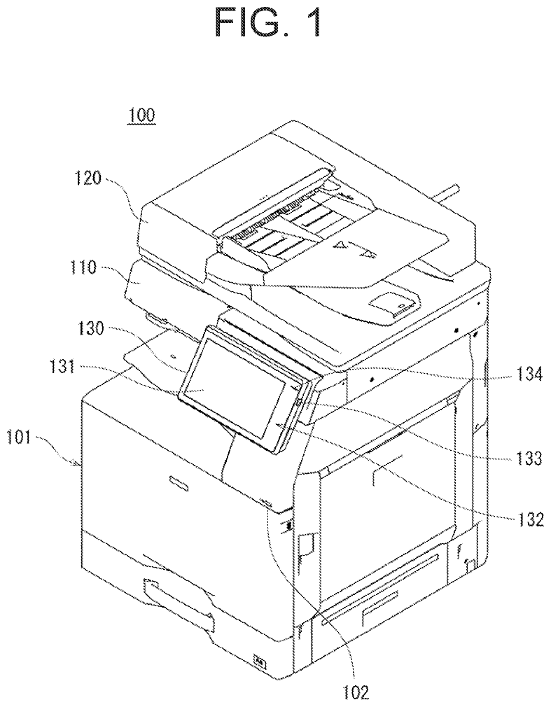

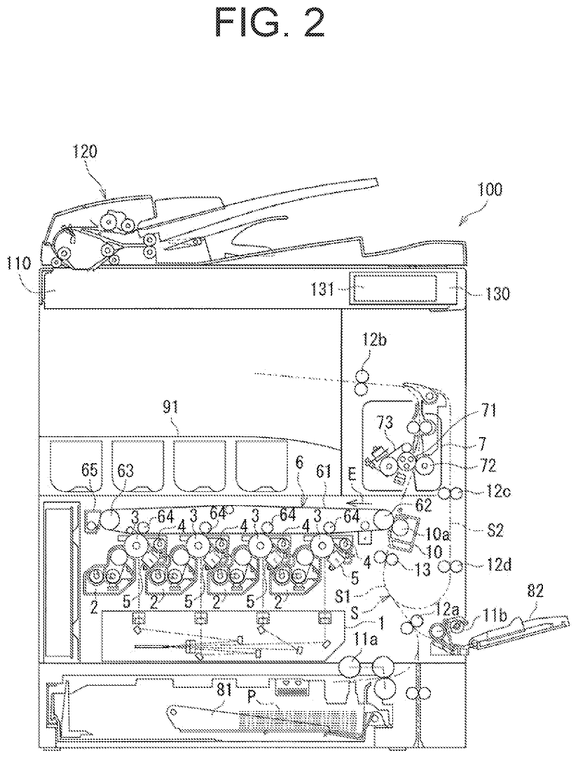

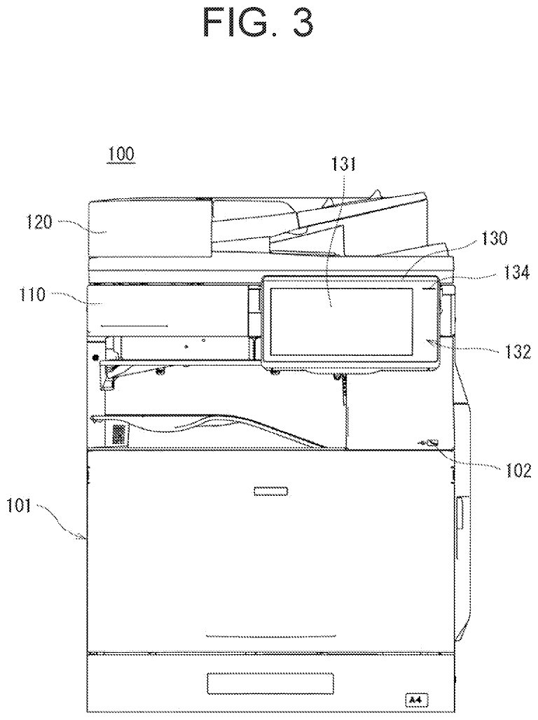

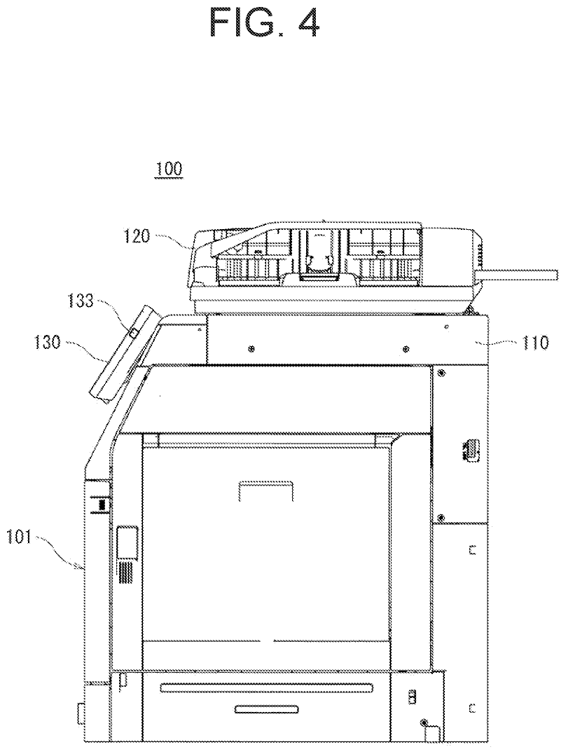

FIG. 1 is an external perspective view illustrating an image forming device according to an embodiment of the present disclosure, FIG. 2 is a schematic configuration diagram of the image forming device illustrated in FIG. 1, FIG. 3 is a front view illustrating the image forming device as viewed from a front surface side of a housing, and FIG. 4 is a lateral view illustrating the image forming device as viewed from a lateral surface side of the housing.

An image forming device 100 is a multifunction peripheral having a scanner function, a copier function, a printer function, a facsimile function, and the like. The image forming device 100 transmits an image of a document read by an image reader 110 to the outside (corresponding to the scanner function) and forms, on a paper sheet, a color or monochrome image of the image of the read document or an image received from the outside (corresponding to the copier function, the printer function, and the facsimile function).

Above the image reader 110, a document feeder (ADF) 120 that is supported so as to be openable and closable with respect to the image reader 110 is provided. When the document feeder 120 is opened, the upper side of the image reader 110 is opened, so that a document (paper sheet) can be placed by hand. Moreover, the document feeder 120 automatically feeds a placed document onto the image reader 110. The image reader 110 reads the placed document or the document fed from the document feeder 120 and generates image data.

The image forming device 100 has a configuration including an exposure device 1, a developing device 2, a photosensitive drum 3, a cleaner device 4, a charger 5, an intermediate transfer belt device 6, a fixing device 7, a paper feed tray 81, a manual feed tray 82, a paper output tray 91, and a paper sheet feed path S and forms a multicolor or monochrome image on a predetermined paper sheet in response to image data transmitted from the outside.

The image data handled in the image forming device 100 is image data corresponding to a color image using respective colors of black (K), cyan (C), magenta (M), and yellow (Y). Therefore, four developing devices 2, four photosensitive drums 3, four chargers 5, and four cleaner devices 4 are provided so as to form four kinds of latent images corresponding to the respective colors and are respectively set to black, cyan, magenta, and yellow, thereby configuring four image stations.

The photosensitive drum 3 is arranged substantially at the center of the image forming device 100. The charger 5 uniformly charges the surface of the photosensitive drum 3 to a predetermined potential. The exposure device 1 exposes the surface of the photosensitive drum 3 to form an electrostatic latent image. The developing device 2 develops the electrostatic latent image on the surface of the photosensitive drum 3 to form a toner image on the surface of the photosensitive drum 3. A toner image of each color is formed on the surface of each photosensitive drum 3 by a series of operations described above. The cleaner device 4 removes and collects residual toner on the surface of the photosensitive drum 3 after development and image transfer.

The intermediate transfer belt device 6 is arranged on the photosensitive drum 3 and includes an intermediate transfer belt 61, an intermediate transfer belt driving roller 62, an intermediate transfer belt driven roller 63, an intermediate transfer roller 64, and an intermediate transfer belt cleaning device 65. Four intermediate transfer rollers 64 are provided corresponding to the image stations of the respective colors of YMCK.

The intermediate transfer belt driving roller 62, the intermediate transfer belt driven roller 63, and the intermediate transfer rollers 64 are configured to stretch the intermediate transfer belt 61 and to move the surface of the intermediate transfer belt 61 in a predetermined direction (the direction of the arrow E in the drawing).

The intermediate transfer belt 61 circularly moves in the direction of the arrow E, residual toner is removed and collected by the intermediate transfer belt cleaning device 65, the toner images of the respective colors formed on the surfaces of the respective photosensitive drums 3 are sequentially transferred and superimposed, and a color toner image is formed on the surface of the intermediate transfer belt 61.

The image forming device 100 further includes a secondary transfer device 10 including a transfer roller 10a. A nip area is formed between the transfer roller 10a and the intermediate transfer belt 61, and the transfer roller 10a catches a paper sheet, which has been fed through the paper sheet feed path S, in the nip area and feeds the paper sheet. When the paper sheet passes through the nip area, the toner image on the surface of the intermediate transfer belt 61 is transferred onto the paper sheet.

The paper feed tray 81 is a tray for storing paper sheets to be used for image formation and is provided below the exposure device 1. The manual feed tray 82 is provided on the lateral surface (right lateral surface in FIG. 1) of the image forming device 100 and is a tray on which paper sheets to be used for image formation can be placed. Moreover, the paper output tray 91 is provided on the upper side of the image forming device 100 and is a tray for placing paper sheets after image formation.

The paper sheet feed path S includes a main path S1 provided in an S-shape and a reverse path S2 that branches off in the middle of the main path S1 and then rejoins the main path S1. Along the main path S1, a pickup roller 11a, a manual pickup roller 11b, a pre-registration roller 12a, a registration roller 13, the secondary transfer device 10, the fixing device 7, and a paper output roller 12b are arranged. The reverse path S2 branches off from between the fixing device 7 and the paper output roller 12b, passes through a reverse feed roller 12c and a reverse feed roller 12d, and rejoins between the pre-registration roller 12a and the registration roller 13.

The pickup roller 11a is disposed in the vicinity of an end portion of the paper feed tray 81 and is an introduction roller that supplies paper sheets one by one from the paper feed tray 81 to the paper sheet feed path S. The registration roller 13 temporarily holds a paper sheet that is being fed from the paper feed tray 81 and then feeds the paper sheet to the transfer roller 10a at a timing when the tip of the toner image on the photosensitive drum 3 aligns with the tip of the paper sheet. The pre-registration roller 12a is a small roller for facilitating and assisting the feeding of the paper sheet.

In the fixing device 7, a pressure roller 72 is pressed against a fixing roller 71, and a heating part 73 for heating the fixing roller 71 is included. In the fixing device 7, a paper sheet with an unfixed toner image formed thereon is received, and the paper sheet is fed while being sandwiched between the fixing roller 71 and the pressure roller 72. The paper sheet after fixation is output onto the paper output tray 91 by the paper output roller 12b.

When image formation is to be performed not only on a front surface but also a rear surface of a paper sheet, the paper sheet is fed in the opposite direction from the paper output roller 12b to the reverse path S2 so as to invert the front and rear surfaces of the paper sheet, the paper sheet is guided again to the registration roller 13, image formation is performed on the rear surface in the same manner as the front surface, and the paper sheet is fed and output to the paper output tray 91.

An operation panel 130 including a display 131 and a storage medium connector 102 are provided on a front surface of a housing 101 of the image forming device 100. In the present embodiment, the display 131 is a touch panel. The operation panel 130 includes a near field communicator 132, an inputter 133, and a notifier 134, in addition to the display 131.

As illustrated in FIG. 3, the near field communicator 132 and the storage medium connector 102 are provided at an end portion on the same side in a lateral direction (left-right direction in FIG. 3) along the front surface of the housing 101. In the present embodiment, the near field communicator 132 and the storage medium connector 102 are provided at the right end portion of the front surface of the housing 101, but the present disclosure is not limited thereto, and both may be provided at the left end portion. As described above, since the near field communicator 132 and the storage medium connector 102 are provided at the end portion on the same side of the housing 101, the central portion of the housing 101 is widely available and can be effectively used.

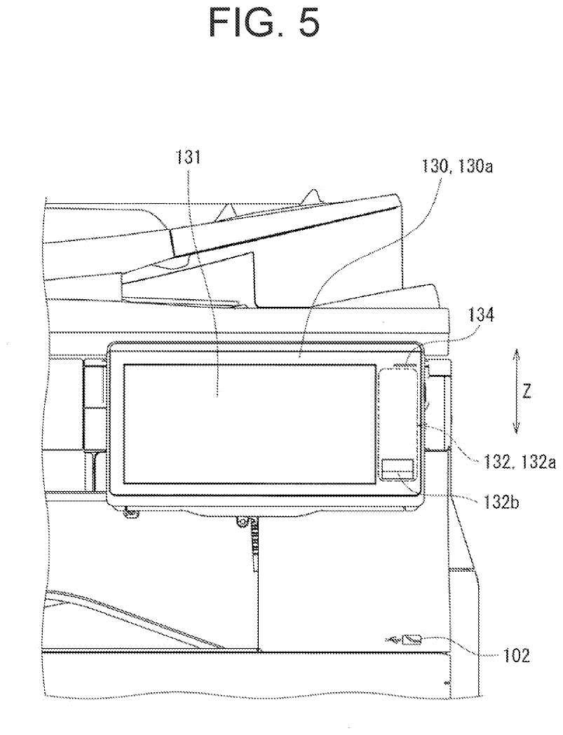

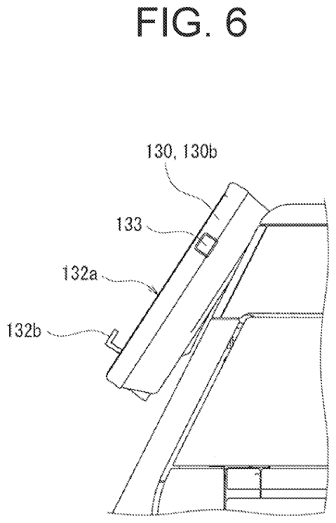

Next, a detailed positional relationship between each component of the operation panel 130 and the storage medium connector 102 will be described with reference to FIG. 5 and FIG. 6.

FIG. 5 is an enlarged front view illustrating an enlarged vicinity of the operation panel as viewed from the front surface side of the housing, and FIG. 6 is an enlarged lateral view illustrating the enlarged vicinity of the operation panel as viewed from the lateral surface side of the housing.

The operation panel 130 is rotatably attached to the image forming device 100 such that a panel front surface 130a (an example of an installation surface) faces obliquely forward and upward, and an angle at which the operation panel 130 faces can be changed by rotating the operation panel 130.

The display 131 occupies a wide range including the left end portion and the central portion of the panel front surface 130a. Moreover, the near field communicator 132 that performs near field communication with a mobile terminal is provided at the right end portion of the panel front surface 130a. In other words, the near field communicator 132 is arranged adjacent to and on the right of the display 131. As described above, since the near field communicator 132 is arranged adjacent to the display 131, a user can easily visually recognize the near field communicator 132 and the display 131 together.

The near field communicator 132 is provided with a placement acceptor 132a on which a mobile terminal is placed, and a supporter 132b for supporting the mobile terminal is provided at a lower end of the placement acceptor 132a. The placement acceptor 132a is a part of the panel front surface 130a and is a flat surface without a step from the periphery. Specifically, as illustrated in FIG. 6, the supporter 132b is provided with a supporting surface protruding from the panel front surface 130a and a locking part erected upward from the tip of the supporting surface, the supporting surface supports a lower end of the mobile terminal, and the locking part prevents the mobile terminal from falling. The supporter 132b is not limited to the above-described structure and may have a part for supporting the mobile terminal, such as a structure in which a plurality of protrusions protruding from the panel front surface 130a are provided. As described above, by providing the supporter 132b, the mobile terminal can be placed on the placement acceptor 132a without being supported by the user, and the operability can be improved.

When the image forming device 100 performs near field communication with a mobile terminal via the near field communicator 132, the mobile terminal can be handled as a part of an input device. As a result, the user can input an instruction to the image forming device 100 by operating the mobile terminal (performing input) without touching the operation panel 130. At this time, if the near field communicator 132 is arranged on the right of the display 131, when the user operates the mobile terminal arranged to face the near field communicator 132 with the right hand, the display 131 is not blocked by the user's hand, and thus the visibility can be improved.

The notifier 134 is an LED arranged above the near field communicator 132 on the panel front surface 130a and provides notification by causing the user to visually recognize emitted light. In other words, a position of the notifier 134 overlaps with a position of the near field communicator 132 in a vertical direction Z in a state where the notifier 134 faces the front surface of the housing 101. As described above, by providing the notifier 134, the user can be notified of various matters. Moreover, since the near field communicator 132 and the notifier 134 are arranged in a straight line, the user's eye gaze can be smoothly guided to both components. The notifier 134 may notify the user whether a power source of the image forming device 100 is turned on or off by switching between lighting and non-lighting or may notify the user of the state of the image forming device 100 by changing the color of emitted light.

As described above, the storage medium connector 102 is provided on the front surface of the housing 101 and is arranged at a position overlapping with a position of the near field communicator 132 in the vertical direction Z. Specifically, the near field communicator 132 is located above the storage medium connector 102. In the present embodiment, the storage medium connector 102 is a USB port, and various storage media such as a USB memory are electrically connected thereto. As described above, since the near field communicator 132 and the storage medium connector 102 are provided on the same surface of the housing 101, the user can install a mobile terminal and connect a storage medium in a state of standing and facing the front surface of the housing 101. Furthermore, since the near field communicator 132 and the storage medium connector 102 are arranged in a straight line, the user can be guided to smoothly move his/her hand and eye gaze when performing an operation for both components. Since the user can visually recognize the storage medium connector 102 in a state of facing the operation panel 130, the user does not need to move and look into a lateral surface in order to visually recognize the storage medium connector 102 and can insert the storage medium such as a USB memory straight without applying a load. Moreover, since the near field communicator 132 is located above the storage medium connector 102 to be operated by hand, the user can smoothly turn the gaze to the mobile terminal.

Next, as illustrated in FIG. 6, the inputter 133 is provided on a lateral surface (panel lateral surface 130b) of the operation panel 130, which is adjacent to the panel front surface 130a on which the display 131 is provided. In the present embodiment, the inputter 133 provided on the panel lateral surface 130b is a power button. As described above, since the inputter 133 is provided on the panel lateral surface 130b of the operation panel 130, an erroneous operation on the inputter 133 when the operation panel 130 is operated can be prevented. The inputter 133 arranged on the panel lateral surface 130b is preferably a button for issuing an important instruction in the operation of the image forming device 100, such as a power button for instructing the operation and stop of the image forming device 100.

In the above-described image forming device 100, the near field communicator 132 corresponding to the mobile terminal, the storage medium connector 102, and the notifier 134 are arranged at positions overlapping one another in the vertical direction Z. Since the components to be visually recognized and operated by the user lie in a straight line, when using the image forming device 100, the user can access the respective components smoothly, and the operability can be improved.

The embodiments disclosed herein are illustrative in all respects and are not intended to be the basis for a limited interpretation. Therefore, the technical scope of the present disclosure is not interpreted only by the above-described embodiments, but is defined on the basis of the statement of the scope of claims. Moreover, all modifications within the meaning and scope equivalent to the scope of claims are included.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image forming device comprising:
a housing;
a near field communicator that performs near field communication with a mobile terminal; and
a storage medium connector to which a storage medium is electrically connected, wherein
the near field communicator and the storage medium connector are provided on a front surface of the housing, and
a position of the near field communicator overlaps with a position of the storage medium connector in a vertical direction in a state where the near field communicator and the storage medium connector face the front surface of the housing.

2. The image forming device according to claim 1, wherein
the near field communicator is located above the storage medium connector.

3. The image forming device according to claim 1, further comprising:
an operation panel attached to the front surface of the housing, wherein
the near field communicator is provided on the operation panel.

4. The image forming device according to claim 3, wherein
a display is provided on the operation panel, and
the near field communicator is arranged adjacent to the display.

5. The image forming device according to claim 4, wherein
the near field communicator is arranged on the right of the display.

6. The image forming device according to claim 4, wherein
an inputter that receives input from a user is provided on the operation panel.

7. The image forming device according to claim 6, wherein
the near field communicator is provided on an installation surface of the operation panel, and
the inputter is provided on a lateral surface of the operation panel, which is adjacent to the installation surface.

8. The image forming device according to claim 1, wherein
the near field communicator has a placement acceptor on which the mobile terminal is placed, and
a supporter that supports the mobile terminal is provided at a lower end of the placement acceptor.

9. The image forming device according to claim 1, further comprising:
a notifier that provides notification to a user by visual recognition, wherein
the notifier is provided on the front surface of the housing, and
a position of the notifier overlaps with the position of the near field communicator in the vertical direction.

10. The image forming device according to claim 1, wherein
the near field communicator and the storage medium connector are provided at an end portion on the same side in a lateral direction along the front surface of the housing.
